(19) United States
(12) Patent Application Publication
(10) Pub. No.: US 2026/0266470 A1
(43) Pub. Date: Sep. 10, 2026

(54) METHOD FOR CONTROLLING A COOKING APPLIANCE

(71) Applicant: ILLINOIS TOOL WORKS INC., Glenview, IL (US)

(72) Inventors: Fabrice AMARI, Breuilpont (FR); Yves LUBRINA, Chaussenans (FR)

(21) Appl. No.: 19/491,291

(22) PCT Filed: Jun. 7, 2024
(86) PCT No.: PCT/US2024/032896

§ 371 Date: Dec. 8, 2025

(30) Foreign Application Priority Data
Jun. 9, 2023 (EP) 23315241.2

(51) Int. Cl. F24C 7/08; G06F 3/0482; G06F 3/04847; G06F 3/0488

(52) U.S. Cl. CPC F24C 7/085; G06F 3/0482; G06F 3/04847; G06F 3/0488

(57) ABSTRACT

A method for controlling a cooking appliance involves receiving, via a user interface, a product type selected among a plurality of selectable product types; displaying, via the user interface and in response to the selected product type, a plurality of cooking categories associated with the selected product type; receiving, via the user interface, a cooking category selected among the plurality of cooking categories displayed; displaying, via the user interface and in response to the selected cooking category, a plurality of cooking styles associated with the selected cooking category; receiving, via the user interface, a cooking style selected among the plurality of cooking styles displayed; and retrieving, from a database of cooking settings, a cooking setting associated with the selected combination of product type, of cooking category and of cooking style.

### TECHNICAL FIELD OF THE INVENTION

The invention generally relates to the field of cooking appliances and more specifically to cooking appliances incorporating a cooking assistant to control a cooking cycle. More specifically, but not exclusively, the present invention relates to a method for controlling such a cooking appliance, in which a cooking setting is determined on the basis of a series of user selections, as well as to a cooking appliance control system and a cooking appliance in which the method can be used.

### TECHNICAL BACKGROUND

There are known cooking assistants with preloaded settings for cooking predetermined food products according to predetermined recipes. However, the number of combinations offered by these known assistants is limited.

### SUMMARY OF THE INVENTION

The present invention aims to provide a more comprehensive set of recipe combinations, with greater flexibility in adjusting the preloaded settings, while minimizing the memory required to store the settings.

The invention generally relates to a cooking appliance control method in which multiple selections, preferably at least three, are carried out to select a predetermined cooking setting.

This makes it possible to accommodate a more comprehensive list of recipes, while simplifying the selection process.

The cooking appliance can comprise a user interface. The cooking appliance can comprise a controller, which can be operationally connected to the user interface.

The method can comprise a receiving step in which a product type is selected among a plurality of selectable product types, for example via the user interface. The method can comprise a display step in which a plurality of cooking categories associated with the selected product type are displayed, for example via the user interface and/or in response to the selected product type. The method can comprise a receiving step in which a cooking category is selected among the plurality of cooking categories displayed, for example via the user interface.

The method can comprise a display step in which a plurality of cooking styles associated with the selected cooking category are displayed, for example via the user interface and/or in response to the selected cooking category. The method can comprise a receiving step in which a cooking style is selected among the plurality of cooking styles displayed, for example via the user interface.

The method can comprise a retrieval step in which a cooking setting associated with the selected combination of product type and/or of cooking category and/or of cooking style is retrieved, for example from a database of cooking settings.

The invention also relates to a cooking appliance control method comprising a user interface and a controller operationally connected to the user interface, characterized in that the method comprises the following steps: receiving, via the user interface, a product type selected among a plurality of selectable product types; displaying, via the user interface and in response to the selected product type, a plurality of cooking categories associated with the selected product type; receiving, via the user interface, a cooking category selected among the plurality of cooking categories displayed; displaying, via the user interface and in response to the selected cooking category, a plurality of cooking styles associated with the selected cooking category; receiving, via the user interface, a cooking style selected among the plurality of cooking styles displayed; retrieving, from a database of cooking settings, a cooking setting associated with the selected combination of product type, of cooking category and of cooking style.

The invention also relates to a cooking appliance control method comprising a user interface and a controller operationally connected to the user interface, characterized in that the method comprises the following steps: receiving, via the user interface, a product type selected among a plurality of selectable product types; displaying, via the user interface and in response to the selected product type, a plurality of cooking styles associated with the selected cooking category; receiving, via the user interface, a cooking style selected among the plurality of cooking styles displayed; retrieving, from a database of cooking settings, a cooking setting associated with the selected combination of product type and of cooking style.

The method can comprise a receiving step in which a product category is selected among a plurality of selectable product categories, for example via the user interface. The method can comprise a display step in which a plurality of product types associated with the selected product category are displayed, for example via the user interface and/or in response to the selected product category.

The selectable product types can correspond to the product types displayed. The selectable product categories can comprise meat and non-meat products.

The selectable product types associated with the meat product category can comprise at least one, for example at least two, of the following products: beef, lamb, duck, veal, chicken, turkey, pork, fish, shellfish, meat casserole and fish casserole.

The selectable product types associated with the non-meat product category can comprise at least one, for example at least two, of the following products: green vegetables, root vegetables, pasta, rice, bread, croissants and pies.

The cooking category display step can be omitted for at least one product type from the plurality of selectable product types. The cooking category step can be omitted from all selectable product types. The selected cooking category receiving step can be omitted for at least one product type from the plurality of selectable product types. The cooking category display and receiving steps can be omitted for at least one product type from the plurality of selectable product types.

The cooking category display step can be omitted for non-meat products. The selected cooking category receiving step can be omitted for non-meat products. The cooking category display and receiving steps can be omitted for non-meat products.

The selectable product categories can comprise two or more categories among red meat, white meat, poultry, fish, vegetables, prepared meals and bakery or pastry products.

The selectable product types associated with the red meat category can comprise at least one, for example at least two, of the following products: beef, lamb, venison, giblets and duck. The selectable product types associated with the red meat category can also comprise prepared meals.

The selectable product types associated with the white meat category can comprise at least one, for example at least two, of the following products: chicken, turkey, pork and sausage. The selectable product types associated with the white meat category can comprise prepared meals.

The selectable product types associated with the poultry category can comprise at least one, for example at least two, of the following products: chicken, turkey, duck, goose, wild fowl, rabbit and terrines. The selectable product types associated with the poultry category can comprise prepared meals.

The selectable product types associated with the fish category can comprise at least one, for example at least two, of the following products: whole fish, fish portions, shellfish, breaded products and frozen products. The selectable product types associated with the fish category can also comprise prepared meals.

The selectable product types associated with the vegetable category can comprise at least one, for example at least two, of the following products: green vegetables, root vegetables, potatoes, pasta, rice and frozen products. The selectable product types associated with the vegetable category can also comprise prepared meals.

The selectable product types associated with the prepared meal category can comprise at least one, for example at least two, of the following products: meat, fish, vegetables, potatoes and frozen foods. The selectable product types associated with the prepared meal category can also comprise prepared meals.

The selectable product types associated with the bakery or pastry product category can comprise at least one, for example at least two, of the following products: bread, croissants, pies, egg desserts, frozen foods, cookies and convenience foods.

The cooking category can comprise a cooking speed and/or a cut of meat.

The selectable cooking styles can comprise at least one, for example two or more, of the following styles: grilled, pan fried, air fried, convenience, breaded, roasted, braised, baked, steamed, sous vide, poached and stewed.

The method can comprise a display step, for example via the user interface, for a core probe selector, which can be for selecting whether or not a core probe is present during a cooking cycle. The method can comprise a receiving step for selecting whether a cooking cycle is to take place with a core probe or without a core probe, for example via the core probe selector displayed on the user interface. The method can comprise an adjustment step for one or more cooking parameters of the cooking setting based on the selection of whether a cooking cycle is to take place with a core probe or without a core probe.

The core probe selector may comprise a toggle button or toggle key.

The method can comprise a display step, for example via the user interface, for a proving selector, which can be for selecting whether or not a proving process is to be carried out. The method can comprise a receiving step for selecting whether or not a proving process is to be carried out, for example via the proving selector displayed on the user interface. The method can comprise an adjustment step for one or more cooking parameters of the cooking setting based on the selection of whether or not a proving process is to be carried out.

The proving selector may comprise a toggle button or toggle key.

The method may comprise displaying the proving selector when a product type associated with the bakery or pastry product category is selected to be bread.

The method can comprise a display step, for example via the user interface, for a setting selector, which can be for adjusting a default product characteristic within the selected product type. The method can comprise a receiving step for an adjustment of the default product characteristic, for example via the setting selector displayed on the user interface. The method can comprise an adjustment step for one or more cooking parameters of the cooking setting retrieved based on the adjusted default product characteristic.

The default product characteristic can be one among a size and a thickness. The cooking parameter(s) of the cooking setting can comprise one or more of the following parameters: ambient temperature, core temperature, humidity and time of one or more steps in the setting.

The method can comprise a display step for one or more setting selectors, for example via the user interface, each of which can be used to adjust a default cooking characteristic in the selected cooking style. The method can comprise a receiving step for an adjustment of the default cooking characteristic(s), for example via the setting selector(s) displayed on the user interface. The method can comprise an adjustment step for one or more cooking parameters of the cooking setting retrieved, for example based on the adjusted default cooking characteristic(s).

The method can comprise displaying one or more setting selectors in dependence on whether a cooking cycle is to take place with a core probe or without a core probe, for example as selected via the core probe selector displayed on the user interface.

The default cooking characteristic can be one among a doneness, a cooking level, an outer appearance, a browning, a cooking speed and a color.

The number of cooking settings saved in the database can be smaller than the number of product type and cooking style combinations. The number of cooking settings saved in the database can be less than one-tenth of the number of product type and cooking style combinations.

The invention also relates to a computer program comprising a computer-readable program code for prompting the execution by a processor of a procedure for implementing the aforementioned method.

The invention also relates to a cooking appliance control system configured to implement the aforementioned method.

The invention also relates to a cooking appliance control system comprising a computer-readable program code for prompting the execution by a processor of a procedure for implementing the aforementioned method.

The cooking appliance can comprise a user interface that can be used to receive inputs from a user and to display information. The cooking appliance can comprise a memory, for example, in which a plurality of cooking settings or a database of cooking settings is saved. The cooking appliance can comprise a controller operationally connected to the user interface and to the memory.

The controller can be configured to receive, for example via the user interface, a product type selected among a plurality of selectable product types. The controller can be configured to display, for example via the user interface and/or in response to the selected product type, a plurality of cooking categories associated with the selected product type. The controller can be configured to receive, for example via the user interface, a cooking category selected among the plurality of cooking categories displayed.

The controller can be configured to display, for example via the user interface and/or in response to the selected cooking category, a plurality of cooking styles associated with the selected cooking category. The controller can be configured to receive, for example via the user interface, a cooking style selected among the plurality of cooking styles displayed.

The controller can be configured to retrieve, for example from the plurality of cooking settings or from the database of cooking settings saved in the memory, a cooking setting associated with the selected combination of product type and/or of cooking category and/or of cooking style.

The invention also relates to a cooking appliance control system comprising: a user interface that can be used to receive inputs from a user and to display information; a memory in which a database of cooking settings is saved; and a controller operationally connected to the user interface and to the memory; in which the controller is configured to: receive, via the user interface, a product type selected among a plurality of selectable product types; display, via the user interface and in response to the selected product type, a plurality of cooking categories associated with the selected product type; receive, via the user interface, a cooking category selected among the plurality of cooking categories displayed; display, via the user interface and in response to the selected cooking category, a plurality of cooking styles associated with the selected cooking category; receive, via the user interface, a cooking style selected among the plurality of cooking styles displayed; retrieve, from the database of cooking settings saved in the memory, a cooking setting associated with the selected combination of product type, of cooking category and of cooking style.

The invention also relates to a cooking appliance control system comprising: a user interface that can be used to receive inputs from a user and to display information; a memory in which a database of cooking settings is saved; and a controller operationally connected to the user interface and to the memory; in which the controller is configured to: receive, via the user interface, a product type selected among a plurality of selectable product types; display, via the user interface and in response to the selected product type, a plurality of cooking styles associated with the selected product type; receive, via the user interface, a cooking style selected among the plurality of cooking styles displayed; retrieve, from the database of cooking settings saved in the memory, a cooking setting associated with the selected combination of product type, of cooking category and of cooking style.

The controller can be configured to receive, for example via the user interface, a product category selected among a plurality of selectable product categories. The controller can be configured to display, for example via the user interface and/or in response to the selected product category, a plurality of product types associated with the selected product category. The selectable product types can correspond to the product types displayed.

The selectable product categories can correspond to meat and non-meat products. The selectable product types associated with the meat product category can correspond to at least one, for example at least two, of the following products: beef, lamb, duck, veal, chicken, turkey, pork, fish, shellfish, meat casserole and fish casserole. The selectable product types associated with the non-meat product category can correspond to at least one, for example at least two, of the following products: green vegetables, root vegetables, pasta, rice, bread, croissants and pies.

Displaying the cooking categories can be omitted for at least one product type from the plurality of selectable product types. Displaying the cooking categories step can be omitted from all selectable product types. Receiving the selected cooking category can be omitted for at least one product type from the plurality of selectable product types. Displaying and receiving the cooking categories can be omitted for at least one product type from the plurality of selectable product types.

Displaying the cooking categories can be omitted for non-meat products. Receiving the selected cooking category can be omitted for non-meat products. Displaying and receiving the cooking categories can be omitted for non-meat products.

The cooking category can comprise a cooking speed and/or a cut of meat. The selectable cooking styles can comprise one or more, for example two or more, of the following styles: grilled, pan fried, air fried, convenience, breaded, roasted, braised, baked, steamed, sous vide, poached and stewed.

The controller can be configured to display, for example via the user interface, a setting selector, which can be for adjusting a default product characteristic within the selected product type. The controller can be configured to receive, for example via the setting selector displayed on the user interface, an adjustment to the default product characteristic. The controller can be configured to adjust one or more cooking parameters of the retrieved cooking setting, for example based on the adjusted default product characteristic.

The default product characteristic can be one among a size and a thickness.

The cooking parameter(s) of the cooking setting can comprise one or more of the following parameters: ambient temperature, core temperature, humidity and time of one or more steps in the setting.

The controller can be configured to display, for example via the user interface, a core probe selector, which can be for selecting whether or not a core probe is present during a cooking cycle. The controller can be configured to receive, for example via the core probe selector displayed on the user interface, a user selection of whether a cooking cycle is to take place with a core probe or without a core probe. The controller can be configured to adjust one or more cooking parameters of the cooking setting, for example based on the use selection of whether a cooking cycle is to take place with a core probe or without a core probe.

The core probe selector may comprise a toggle button or toggle key.

The controller can be configured to display, for example via the user interface, a proving selector, which can be for selecting whether or not a proving process is to be carried out. The controller can be configured to receive, for example via the proving selector displayed on the user interface, a user selection of whether or not a proving process is to be carried out. The controller can be configured to adjust one or more cooking parameters of the cooking setting, for example based on the user selection of whether or not a proving process is to be carried out.

The proving selector may comprise a toggle button or toggle key.

The controller can be configured to display the proving selector, for example via the user interface, when a product type associated with the bakery or pastry product category is selected to be bread.

The controller can be configured to display, for example via the user interface, one or more setting selectors, each of which can be used to adjust a default cooking characteristic in the selected cooking style. The controller can be configured to receive, for example via the setting selector(s) displayed on the user interface, an adjustment to the default product characteristic(s). The controller can be configured to adjust one or more cooking parameters of the retrieved cooking setting, for example based on the adjusted default product characteristic(s).

The controller can be configured to display one or more setting selectors in dependence on whether a cooking cycle is to take place with a core probe or without a core probe, for example as selected via the core probe selector displayed on the user interface.

The default cooking characteristic can be one among a doneness, a cooking level, an outer appearance, a browning, a cooking speed and a color.

The number of cooking settings saved in the database can be smaller than the number of product type and cooking style combinations. The number of cooking settings saved in the database can be less than one-tenth of the number of product type and cooking style combinations.

The provision of default product characteristics and setting selectors to adjust them makes it easy to use common settings for a multitude of different combinations of product types and cooking styles. In addition, the controller could be configured to select one of the common settings, but with different default product characteristics, depending, for example, on the type of product selected. Other configurations are also possible to further reduce the number of settings saved in the database.

The user interface can comprise a touch screen, which can be configured to display a plurality of drop-down menus and/or icons. The drop-down menus and/or icons can each represent a respective selection.

The invention also relates to a cooking appliance. The cooking appliance can comprise the aforementioned computer program and/or the aforementioned cooking appliance control system.

The cooking appliance can comprise an oven.

For the avoidance of doubt, all the features described herein also apply to any aspect of the invention.

As part of this application, it is expressly provided that the various aspects, embodiments, examples and alternatives disclosed in the preceding paragraphs, in the claims and/or in the following description and drawings, and in particular the individual features thereof, can be taken separately or in any combination. In other words, all embodiments and/or features of any embodiment can be combined in any way, unless these features are incompatible.

For the avoidance of doubt, the terms “can”, “and/or”, “for example”, “for example” and any other similar term used herein must be interpreted as not limiting, such that any feature described herein is not necessarily required to be present. Indeed, any combination of optional features is expressly foreseen without departing from the scope of the invention, whether or not they are expressly claimed. The applicant reserves the right to amend any claim originally filed or to file any new claim accordingly, including the right to amend any claim originally filed to depend on and/or incorporate any feature of any other claim, though it is not originally claimed in this manner.

### BRIEF DESCRIPTION OF THE FIGURES

Other features and advantages of the invention will become apparent from the following detailed description, which will be understood in reference to the appended drawings, in which:

FIG. 1 illustrates a cooking appliance according to the invention;

FIG. 2 illustrates a home screen displayed on the user interface of the cooking appliance in FIG. 1;

FIG. 3 is a schematic representation of some of the possible selections from the drop-down menus in FIG. 2;

FIG. 4 is a flowchart of a control process for the cooking appliance shown in FIG. 1.

FIG. 5 illustrates an alternative home screen displayed on the user interface of the cooking appliance in FIG. 1;

FIG. 6 illustrates the home screen of FIG. 5 with one of the drop-down menus expanded; and

FIG. 7 illustrates the home screen of FIG. 5 with another of the drop-down menus expanded.

### DETAILED DESCRIPTION OF THE INVENTION

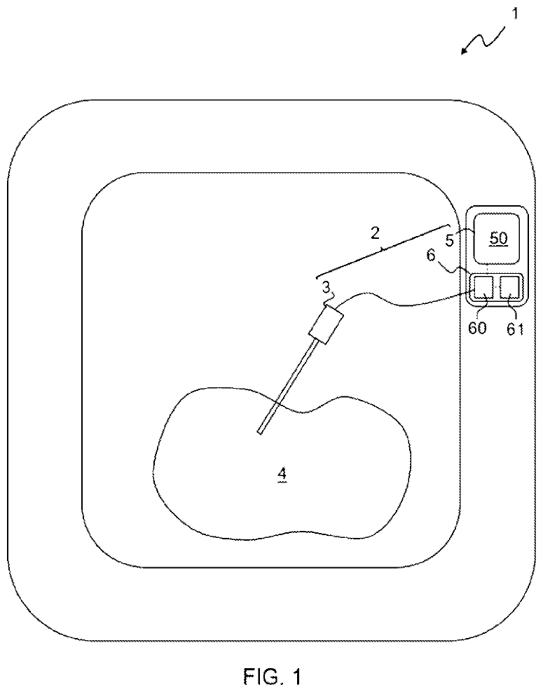

Referring to FIG. 1, a cooking appliance 1 comprising a control system 2 can be seen. The control system 2 comprises a core probe 3 for measuring a core temperature of an item to be cooked 4, a user interface 5 and a controller 6 operationally connected to the core probe 3 and to the user interface 5. The controller 6 comprises a memory 60 and a processor 61 operationally connected to the memory 60.

The user interface 5 comprises a touch screen 50 configured to display information and graphical input means to enable a user to enter information and prompts.

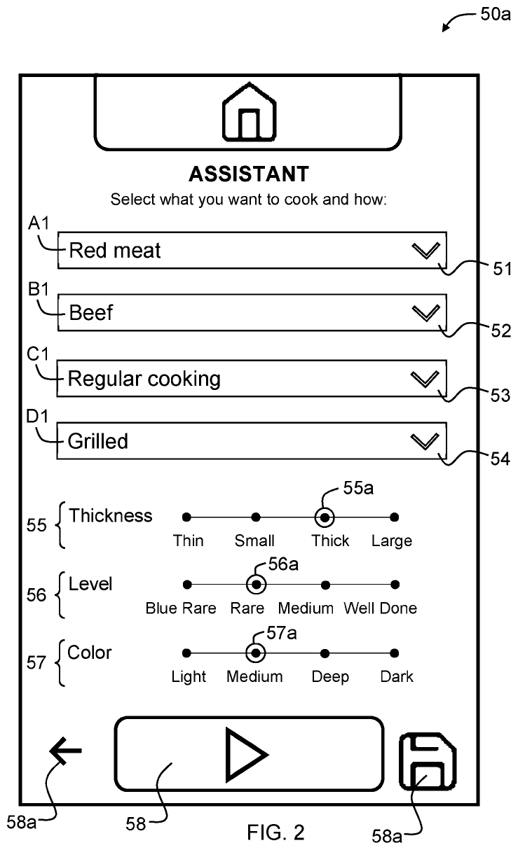

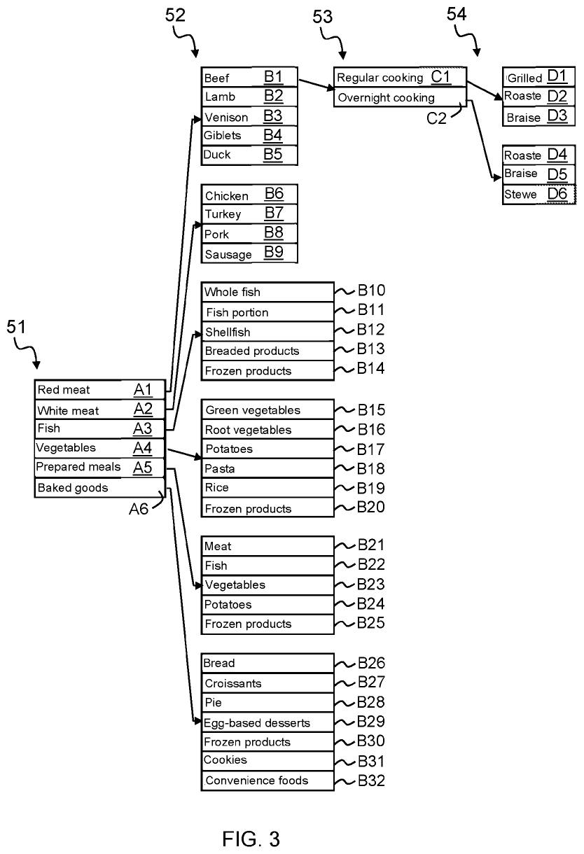

FIG. 2 shows a home screen 50a displayed on the touch screen 50. The home screen 50a comprises several drop-down menus 51, 52, 53, 54, setting selectors 55, 56, 57 and icons 58, 59a, 59b. A hierarchy of selections for drop-down menus 51, 52, 53, 54 is illustrated in FIG. 3.

In this example, the first drop-down menu 51 lists product categories, particularly red meat A1, white meat A2, fish A3, vegetables A4, prepared meals A5 and bakery products A6. Each of these categories A1-A5 is associated with a series of product types B1-B5, B6-B9, B10-B14, B15-B20, B21-B25 and B26-B32, which can be selected from the second drop-down menu 52. The product types in the first category, red meat A1, comprise for example beef B1, lamb B2, venison B3, giblets B4 and duck B5. The other categories A2-A6 each comprise a specific list of product types B1-B5, B6-B9, B10-B14, B15-B20, B21-B25 and B26-B32.

Before selecting the A1-A6 product category, the second drop-down menu 52 contains no options. In response to the selection of an A1-A6 product category in the first drop-down menu 51, the appropriate list of product types B1-B5, B6-B9, B10-B14, B15-B20, B21-B25 and B26-B32 is displayed in the second drop-down menu 52, simplifying the selection for the user.

Likewise, each B1-B32 product type is associated with a series of cooking categories C1, C2, which can be selected using the third drop-down menu 53. For the sake of simplicity, only cooking categories C1, C2 associated with the first product type, beef B1, are shown in FIG. 3. Each cooking category C1, C2 comprises a series of cooking styles D1-D3 and D4-D6, which can be selected using the fourth drop-down menu 54. Only cooking modes D1-D3 and D4-D6 corresponding to cooking categories C1, C2 for beef B1 are shown.

As with the second drop-down menu 52, the appropriate list of cooking categories C1, C2 is only shown in the third drop-down menu 53 after a B1-B32 product type is selected. Likewise, the appropriate list of cooking modes D1-D3 and D4-D6 is displayed in the fourth drop-down menu 54 only after a C1, C2 cooking category has been selected. It should be noted, however, that for some of the B1-B32 product types, notably the B15-B20 and B26-B32 non-meat products, the selection of a cooking category can be omitted.

This invention enables the user to select a suitable cooking program using four simple selections 51, 52, 53, 54. In response to the selection, the controller 6 retrieves the appropriate setting from a database of settings saved in the memory 60. Advantageously, the number of cooking settings saved in the database is substantially smaller than the number of product type and cooking style combinations. In other words, the inventors have ascertained that the same cooking setting can be used for several different combinations, thereby considerably reducing the database memory 60 requirements and increasing the responsiveness of the controller 6. In fact, it was found that the number of settings can be less than one-tenth of the number of combinations of product types and cooking styles.

Each cooking setting comprises one or more default product characteristics and/or one or more default cooking characteristics. The invention makes it possible to adjust these default characteristics using setting selectors 55, 56, 57. For example, three setting selectors 55, 56, 57 are displayed when the cooking setting of the specific selection illustrated in FIG. 2 is selected.

A first setting selector 55 is used to set the thickness of the product and, by default, selection 55a is “thick.” The user can change this selection 55a by simply touching one of the other options, in this case “thin”, “small” or “large.” A second setting selector 56 is used to set the cooking level and, by default, selection 56a is “rare.” The user can change this selection 55a by simply touching one of the other options, in this case “blue rare”, “medium” or “well done.” A third setting selector 57 is used to adjust the color and, by default, selection 57a is “medium.” The user can change this selection 55a by simply touching one of the other options, in this case “light”, “deep” or “dark.” In response to the user's adjustments to selections 55a, 56a, 57a, the controller 6 adjusts one or more cooking parameters of the selected cooking setting. In this example, the cooking parameters of the cooking setting that are adjusted by the user's settings for selections 55a, 56a, 57a comprise one or more of the following parameters: ambient temperature, core temperature, humidity and time of one or more steps of the setting. Adjustments to other cooking parameters are also foreseen.

The user can then select the cook start icon 58 to start the cooking cycle based on the adjusted setting. It is also foreseen to save the adjusted setting to a floppy disk using one of the icons 58a. In this case, a new setting would be saved in the memory 60, which could be retrieved at a later date. Although the controller 6 can be configured to replace the appropriate setting in the database, it is preferable that a new setting is created which can be associated with a user profile.

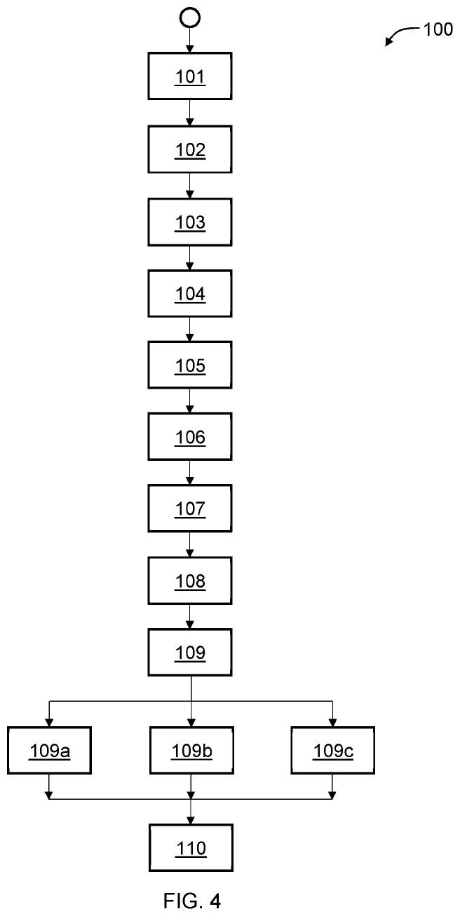

As summarized in FIG. 4, the invention provides a control method 100 for a cooking appliance 1 comprising the following steps:
displaying 101, via the user interface 5, a first drop-down menu 51 comprising a plurality of selectable product categories A1-A6;
receiving 102, via the first drop-down menu 51 on the user interface 5, a selection of product category A1 among a plurality of selectable product categories A1-A6;
displaying 103, via the user interface 5 and in response to the selection of product category A1, a second drop-down menu 52 comprising a plurality of product types B1-B5 associated with the selection of product category A1;
receiving 104, via the second drop-down menu 52 on the user interface 5, a selection of product type B1 among the plurality of product types B1-B5 displayed;
displaying 105, via the user interface 5 and in response to the selection of product type B1, a third drop-down menu 53 comprising a plurality of cooking categories C1, C2 associated with the selection of product type B1;
receiving 106, via the third drop-down menu 53 on the user interface 5, a selection of cooking category C1 among the plurality of cooking categories C1, C2 displayed;
displaying 107, via the user interface 5 and in response to the selection of cooking category C1, a fourth drop-down menu 52 comprising a plurality of cooking styles D1-D3 associated with the selection of cooking category C1;
receiving 108, via the fourth drop-down menu 52 on the user interface 5, a selection of cooking style D1 among the plurality of cooking styles D1-D3 displayed;
retrieving 108, from the database of cooking settings saved in the memory 60, a cooking setting associated with the selected combination of product category A1, of product type B1, of cooking category C1 and of cooking style D1;
displaying 109, via the user interface 5, setting selectors 55, 56, 57 each for adjusting a respective default product characteristic of the selected product type B1;
receiving 109a, 109b, 109c, via the setting selector displayed on the user interface, an adjustment of the default product characteristic; and
adjusting 110 one or more cooking parameters of the cooking setting retrieved based on the adjusted default product characteristic 55a, 56a, 57a.

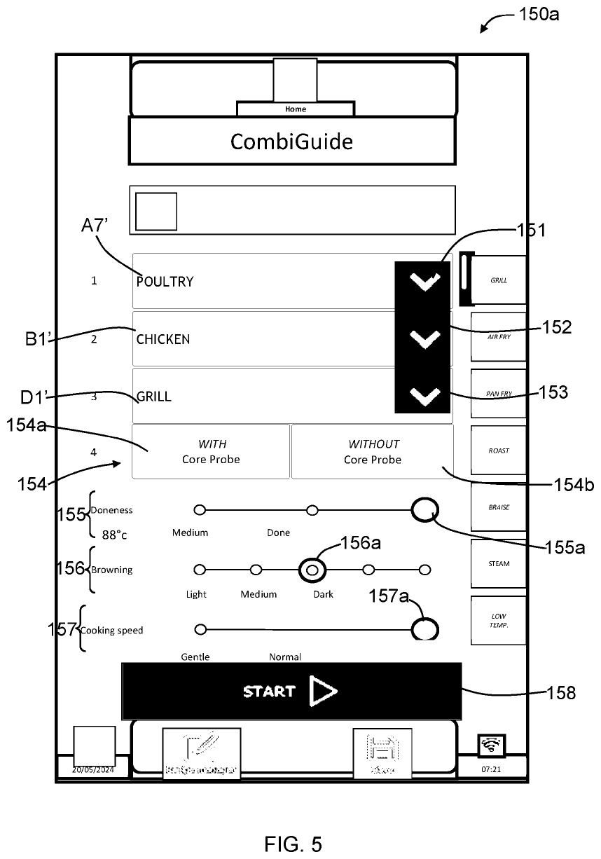

FIG. 5 shows an alternative home screen 150a displayed on the touch screen 50. The home screen 150a comprises several drop-down menus 151, 152 and 154, setting selectors 155, 156, 157 and icons 158, 159a, 159b. The home screen 150a is similar to home screen of FIG. 2, and only the differences will be described hereinafter. The home screen 150a is absent the cooking categories C1, C2, which can be selected using the third drop-down menu 53. The hierarchy of selections for drop-down menus 151, 152 and 154 is illustrated in FIG. 3, but the selections are by no means limited thereto.

In this example, the first drop-down menu 151 lists product categories, one of which is poultry A7′ as is shown in FIGS. 5 to 7. Each of the product categories, e.g. A1-A6 or A7′ is associated with a series of product types, for example B1-B5, B6-B9, B10-B14, B15-B20, B21-B25 and B26-B32 of FIG. 3, which can be selected from the second drop-down menu 152.

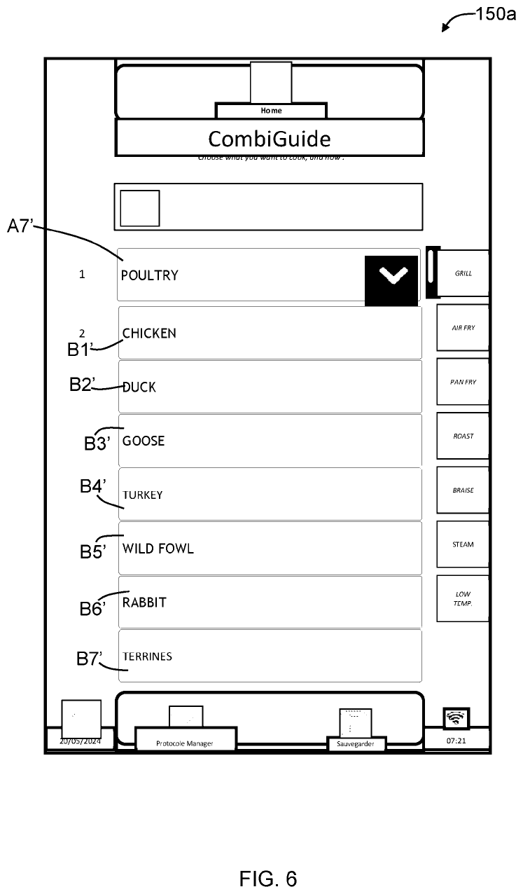

Before selecting the A1-A6 or A7′ product category, the second drop-down menu 152 contains no options. In response to the selection of an A1-A6 or A7′ product category in the first drop-down menu 151, the appropriate list of product types B1-B5, B6-B9, B10-B14, B15-B20, B21-B25 and B26-B32 is displayed in the second drop-down menu 152, simplifying the selection for the user. As is shown in FIG. 6, when the product category poultry A7′ is selected from the first drop-down menu 151, the product types B1′-B7′ are displayed in the second drop-down menu 152.

In this case, each product type B1′-B7′ is not associated with a series of cooking categories C1, C2, as can be selected using the third drop-down menu 53 in FIG. 2.

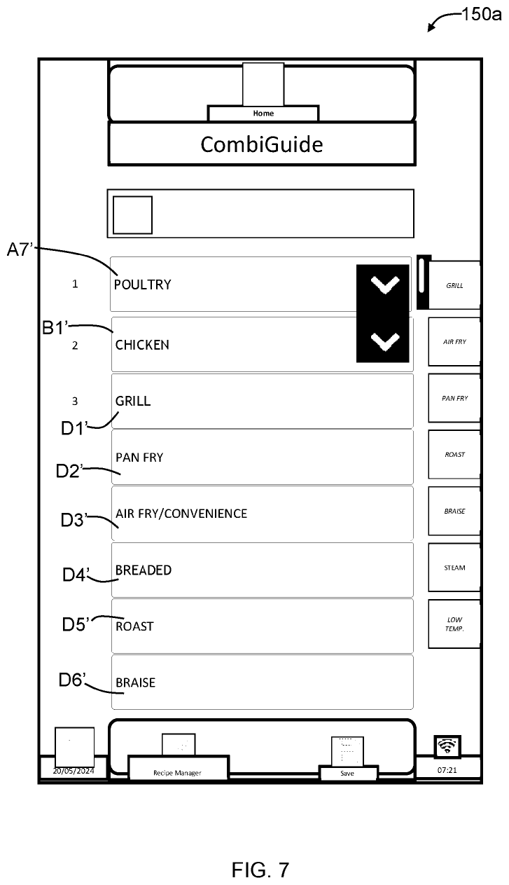

Instead, each product type B1′-B7′ comprises a series of cooking styles D1′-D6′, which can be selected using the third drop-down menu 153, as is shown in FIG. 7. In FIG. 7, only cooking styles D1′-D6′ corresponding to product type chicken B1′ are shown.

As with the second drop-down menu 152, the appropriate list of cooking styles D1′-D6′ is only shown in the third drop-down menu 153 after a B1-B32 or B1′-B7′ product type is selected.

In this example, once the cooking style D1′-D6′ is selected using the third drop-down menu 153, a core probe selector 154 is displayed. The core probe selector 154 provides a toggle or key and allows a user to select whether or not a core probe is present during a cooking cycle. In this example, the core probe selector 154 has a first “with core probe” option 154a and a second “without core probe” option 154b. One or more cooking parameters of the cooking setting is adjusted based on the selection of whether a cooking cycle is to take place with a core probe or without a core probe.

In some examples, a proving selector may be displayed instead of the core probe selector 154, which can be for selecting whether or not a proving process is to be carried out. The proving selector may be displayed a product type associated with the baked goods product category A6 is selected to be bread B26.

This invention enables the user to select a suitable cooking program using four simple selections 151, 152, 153, 154. In response to the selection, the controller 6 retrieves the appropriate setting from a database of settings saved in the memory 60.

Similar to the example of FIG. 2, each cooking setting comprises one or more default product characteristics and/or one or more default cooking characteristics. The invention makes it possible to adjust these default characteristics using setting selectors 155, 156, 157. For example, three setting selectors 155, 156, 157 are displayed when the cooking setting of the specific selection illustrated in FIG. 5 is selected.

A first setting selector 155 is used to set the doneness of the product and, by default, selection 155a is “done”. The user can change this selection 155a by simply touching one of the other options, in this case “medium”. A second setting selector 156 is used to set the browning level and, by default, selection 156a is “medium.” The user can change this selection 156a by simply touching one of the other options, in this case “light”, “medium” or “dark.” A third setting selector 157 is used to adjust the cooking speed and, by default, selection 157a is “normal.” The user can change this selection 157a by simply touching one of the other options, in this case “gentle”.

In response to the user's adjustments to selections 155a, 156a, 157a, the controller 6 adjusts one or more cooking parameters of the selected cooking setting. In this example, the cooking parameters of the cooking setting that are adjusted by the user's settings for selections 155a, 156a, 157a comprise one or more of the following parameters: ambient temperature, core temperature, humidity and time of one or more steps of the setting. Adjustments to other cooking parameters are also foreseen.

The user can then select the cook start icon 158 to start the cooking cycle based on the adjusted setting.

Throughout the description and claims, the words “comprise” and “contain” and their variations mean “including but not limited to” and are not intended for (and do not exclude) other parts, additives, components, integers or steps. Throughout the description and claims of this specification, the singular includes the plural, unless the context requires otherwise. In particular, when the indefinite article is used, the specification should be understood to include the plural as well as the singular, unless the context requires otherwise.

Any features, integers, characteristics, compounds or groups described in connection with a particular aspect, embodiment or example of the invention are to be understood as being applicable to any other aspect, embodiment or example described herein, unless inconsistent therewith. The reader's attention is drawn to all papers and documents that are filed concurrently or prior to this specification in connection with this application and that are open for public inspection with this specification, and the content of all such papers and documents is incorporated herein by reference.

1. A method for controlling a cooking appliance comprising a user interface and a controller operationally connected to the user interface, characterized in that the method comprises the following steps:
receiving, via the user interface, a product type selected among a plurality of selectable product types;
displaying, via the user interface and in response to the selected product type, a plurality of cooking categories associated with the selected product type;
receiving, via the user interface, a cooking category selected among the plurality of cooking categories displayed;
displaying, via the user interface and in response to the selected cooking category, a plurality of cooking styles associated with the selected cooking category;
receiving, via the user interface, a cooking style selected among the plurality of cooking styles displayed;
retrieving, from a database of cooking settings, a cooking setting associated with the selected combination of product type, of cooking category and of cooking style.

2. The cooking appliance control method according to claim 1, in which the method comprises the following steps:
receiving, via the user interface, a product category selected among a plurality of selectable product categories; and
displaying, via the user interface and in response to the selected product category, a plurality of product types associated with the selected product category;
the selectable product types correspond to the product types displayed.

3. The cooking appliance control method according to claim 2, in which the selectable product categories comprise meat and non-meat products.

4. The cooking appliance control method according to claim 3, in which:
the selectable product types associated with the meat product category comprise at least two of the following products: beef, lamb, duck, veal, chicken, turkey, pork, fish, shellfish, meat casserole and fish casserole; and
the selectable product types associated with the non-meat product category comprise at least two of the following products: green vegetables, root vegetables, pasta, rice, bread, croissants and pies.

5. The cooking appliance control method according to claim 3, in which the display and receiving steps for the cooking categories are omitted for non-meat products.

6. The cooking appliance control method according to claim 1, in which the cooking category comprises a cooking speed and/or a cut of meat.

7. The cooking appliance control method according to claim 1, in which the selectable cooking styles comprise two or more of the following styles: grilled, roasted, braised, baked, steamed, sous-vide, poached and stewed.

8. The cooking appliance control method according to claim 1, comprising the following steps:
displaying, via the user interface, a setting selector for adjusting a default product characteristic within the selected product type;
receiving, via the setting selector displayed on the user interface, an adjustment of the default product characteristic; and
adjusting one or more cooking parameters of the cooking setting retrieved based on the adjusted default product characteristic.

9. The cooking appliance control method according to claim 8, in which the default product characteristic is one among size and thickness.

10. The cooking appliance control method according to claim 1, comprising the following steps:
displaying, via the user interface, one or more setting selectors, each of which can be used to adjust a default cooking characteristic in the selected cooking style;
receiving, via the setting selector(s) displayed on the user interface, an adjustment of the default cooking characteristic(s); and
adjusting one or more cooking parameters of the cooking setting retrieved based on the adjusted default cooking characteristic(s).

11. The cooking appliance control method according to claim 10, in which the default cooking characteristic is one among a cooking level, an outer appearance and a color.

12. The cooking appliance control method according to claim 8, in which the cooking parameter(s) of the cooking setting comprise(s) one or more of the following parameters: ambient temperature, core temperature, humidity and time of one or more setting steps.

13. The cooking appliance control method according to claim 1, in which the number of cooking settings saved in the database is smaller than the number of product type and cooking style combinations.

14. The cooking appliance control method according to claim 13, in which the number of cooking settings saved in the database is less than one-tenth of the number of product type and cooking style combinations.

15. A system for controlling a cooking appliance comprising:
a user interface used to receive inputs from a user and to display information;
a memory in which a database of cooking settings is saved; and
a controller operationally connected to the user interface and to the memory;
in which the controller is configured for:
receiving, via the user interface, a product type selected among a plurality of selectable product types;
displaying, via the user interface and in response to the selected product type, a plurality of cooking categories associated with the selected product type;
receiving, via the user interface, a cooking category selected among the plurality of cooking categories displayed;
displaying, via the user interface and in response to the selected cooking category, a plurality of cooking styles associated with the selected cooking category;
receiving, via the user interface, a cooking style selected among the plurality of cooking styles displayed;
retrieving, from the database of cooking settings saved in the memory, a cooking setting associated with the selected combination of product type, of product category and of cooking style.

16. The cooking appliance control system according to claim 15, in which the controller is configured for:
receiving, via the user interface, a product category selected among a plurality of selectable product categories; and
displaying, via the user interface and in response to the selected product category, a plurality of product types associated with the selected product category;
the selectable product types correspond to the product types displayed.

17. The cooking appliance control system according to claim 16, in which the selectable product categories comprise meat and non-meat products.

18. The cooking appliance control system according to claim 17, in which:
the selectable product types associated with the meat product category comprise at least two of the following products: beef, lamb, duck, veal, chicken, turkey, pork, fish, shellfish, meat casserole and fish casserole; and
the selectable product types associated with the non-meat product category comprise at least two of the following products: green vegetables, root vegetables, pasta, rice, bread, croissants and pies.

19. The cooking appliance control system according to claim 16, in which displaying and receiving the cooking categories are omitted for non-meat products.

20. The cooking appliance control system according to claim 15, in which the cooking category comprises a cooking speed and/or a cut of meat.

21. The cooking appliance control system according to claim 15, in which the selectable cooking styles comprise two or more of the following styles: grilled, roasted, braised, baked, steamed, sous-vide, poached and stewed.

22. The cooking appliance control system according to claim 15, in which the controller is configured for:
displaying, via the user interface, a setting selector for adjusting a default product characteristic within the selected product type;
receiving, via the setting selector displayed on the user interface, an adjustment of the default product characteristic; and
adjusting one or more cooking parameters of the cooking setting retrieved based on the adjusted default product characteristic.

23. The cooking appliance control system according to claim 22, in which the default product characteristic is one among size and thickness.

24. The cooking appliance control system according to claim 15, in which the controller is configured for:
displaying, via the user interface, one or more setting selectors, each of which can be used to adjust a default cooking characteristic in the selected cooking style;
receiving, via the setting selector(s) displayed on the user interface, an adjustment of the default cooking characteristic(s); and
adjusting one or more cooking parameters of the cooking setting retrieved based on the adjusted default cooking characteristic(s).

25. The cooking appliance control system according to claim 24, in which the default cooking characteristic is one among a cooking level, an outer appearance and a color.

26. The cooking appliance control system according to claim 22, in which the cooking parameter(s) of the cooking setting comprise(s) one or more of the following parameters: ambient temperature, core temperature, humidity and time of one or more setting steps.

27. The cooking appliance control system according to claim 15, in which the number of cooking settings saved in the database is smaller than the number of product type and cooking style combinations.

28. The cooking appliance control system according to claim 27, in which the number of cooking settings saved in the database is less than one-tenth of the number of product type and cooking style combinations.

29. The cooking appliance control system according to claim 15, in which the user interface comprises a touch screen configured to display a plurality of drop-down menus and/or icons each representing a respective selection.

30. A cooking appliance comprising a cooking appliance control system according to claim 15.
